(19) United States
(12) Patent Application Publication
(10) Pub. No.: US 2009/0271112 A1
(43) Pub. Date: Oct. 29, 2009

(54) DEDICATED SHORT RANGE COMMUNICATION (DSRC) SENDER VALIDATION USING GPS PRECISE POSITIONING TECHNIQUES

(75) Inventor: Chaminda Basnayake, Windsor (CA)

Correspondence Address: MILLER IP GROUP, PLC;GENERAL MOTORS CORPORATION, 42690 WOODWARD AVENUE, SUITE 200, BLOOMFIELD HILLS, MI, 48304, US

(73) Assignee: GM GLOBAL TECHNOLOGY OPERATIONS, INC., DETROIT, MI (US)

(21) Appl. No.: 12/111,466

(22) Filed: Apr. 29, 2008

(51) Int. Cl. G01C 21/00

(52) U.S. Cl. 701/213

(57) ABSTRACT

A system and method for authenticating a message transmitted in a vehicle-to-vehicle communications system. The sending vehicle will attach raw GPS data to a transmitted message it receives from GPS satellites that the sending vehicle uses to determine its own position. The transmitted message will also include the position of the sending vehicle that the sending vehicle has determined using the GPS data. The receiving vehicle will use the raw GPS data in the message and an RTK process to determine the position of the sending vehicle. The receiving vehicle will compare the position of the sending vehicle in the message with the position of the sending vehicle determined from the GPS data, and if they match, will authenticate the received message.

### BACKGROUND OF THE INVENTION

1. Field of the Invention

This invention relates generally to a system and method for authenticating a message sent from one vehicle to another vehicle and, more particularly, to a system and method for authenticating a message sent from one vehicle to another vehicle, where the system and method employ real-time kinematic (RTK) positioning in a validation process using raw GPS data received by the one vehicle that is transmitted from the one vehicle to the other vehicle with the message.

2. Discussion of the Related Art

Traffic accidents and roadway congestion are significant problems for vehicle travel. Vehicular ad-hoc network based active safety and driver assistance systems are known that allow a vehicle communications system to transmit messages to other vehicles in a particular area with warning messages about dangerous road conditions, driving events, accidents, etc. In these systems, multi-hop geocast routing protocols, known to those skilled in the art, are commonly used to extend the reachability of the warning messages, i.e., to deliver active messages to vehicles that may be a few kilometers away from the road condition, as a one-time multi-hop transmission process. In other words, an initial message advising drivers of a potential hazardous road condition is transferred from vehicle to vehicle using the geocast routing protocol so that vehicles a significant distance away will receive the messages because one vehicle's transmission distance is typically relatively short.

Vehicle-to-vehicle (V2V) and vehicle-to-infrastructure (V2I), collectively known as V2X, communications systems of the type being described herein require a minimum of one entity to send information to another entity. For example, many vehicle-to-vehicle safety applications can be executed on one vehicle by simply receiving broadcast messages from a neighboring vehicle. These messages are not directed to any specific vehicle, but are meant to be shared with a vehicle population to support the safety application. In these types of applications, where collision avoidance is desirable, as two or more vehicles talk to each other and a collision becomes probable, the vehicle systems can warn the vehicle drivers, or possibly take evasive action for the driver, such as applying the brakes. Likewise, traffic control units can observe the broadcast of information and generate statistics on traffic flow through a given intersection or roadway.

It is desirable to ensure the validity of a message sent from a vehicle in a V2X system so that the vehicle receiving the message will know that it is authentic. Particularly, it is generally necessary that the information received from a vehicle in these types of vehicle-o-vehicle communications system is reliable to ensure that a vehicle is not attempting to broadcast malicious information that could result in harmful activity, such as a vehicle collision. One current solution for providing trust of the information broadcasted is by transmitting public keys, referred to as public key infrastructure (PKI), so that a vehicle that transmits a certain key is identified as a trusted source. However, transmitting a key between vehicles for identification purposes has a number of drawbacks particularly in system scalability. For example, the number of vehicles that may participate in a vehicle-to-vehicle communications system could exceed 250,000,000 vehicles in the United States alone. Also, the transmission of the key has limitations as to its timeliness of access to the PKI while on the road, the availability of the PKI from anywhere, the bandwidth to the PKI for simultaneous access and the computations needed for PKI certification, reissuance, etc.

GPS measurements contain errors caused by the satellite clock, orbit errors, environmental errors, such as tropospheric and ionospheric delays, user equipment errors, such as clock errors, etc. In order to correct these errors, RTK positioning, well known to those skilled in the art, is used between receiver and satellite to provide difference measurements for relative positioning. Particularly, when measurements to the same satellite by two users are differenced, all satellite and environmental errors are eliminated depending on how close the users are. When measurements to two satellites by the same user are differenced, all user equipment errors are eliminated. RTK techniques use carrier phase measurements as range measurements are too noisy for differencing where error cancelation benefits are less than noise amplification in differencing.

### SUMMARY OF THE INVENTION

In accordance with the teachings of the present invention, a system and method are disclosed for authenticating a message transmitted in a vehicle-to-vehicle communications system. The sending vehicle will attach raw GPS data to a transmitted message it receives from GPS satellites that the sending vehicle uses to determine its own position. The transmitted message will also include the position of the sending vehicle that the sending vehicle has determined using the GPS data. The receiving vehicle will use the raw GPS data in the message and an RTK process to determine the position of the sending vehicle. The receiving vehicle will compare the position of the sending vehicle in the message with the position of the sending vehicle determined from the GPS data, and if they match, will authenticate the received message.

Additional features of the present invention will become apparent from the following description and appended claims, taken in conjunction with the accompanying drawings.

### BRIEF DESCRIPTION OF THE DRAWINGS

FIG. 1 is an illustration of two vehicles employing a vehicle-to-vehicle communications system that receive GPS signals from a constellation of satellites;

FIG. 2 is a block diagram of a dedicated short range communications (DSRC) system on a sending vehicle, according to an embodiment of the present invention; and

FIG. 3 is a block diagram of a dedicated short range communications (DSRC) system on a receiving vehicle, according to an embodiment of the present invention.

### DETAILED DESCRIPTION OF THE EMBODIMENTS

The following discussion of the embodiments of the invention directed to a dedicated short range communications system for vehicle communications that employs a technique for using raw GPS measurements to validate a sending vehicles message is merely exemplary in nature, and is in no way intended to limit the invention or its applications or uses.

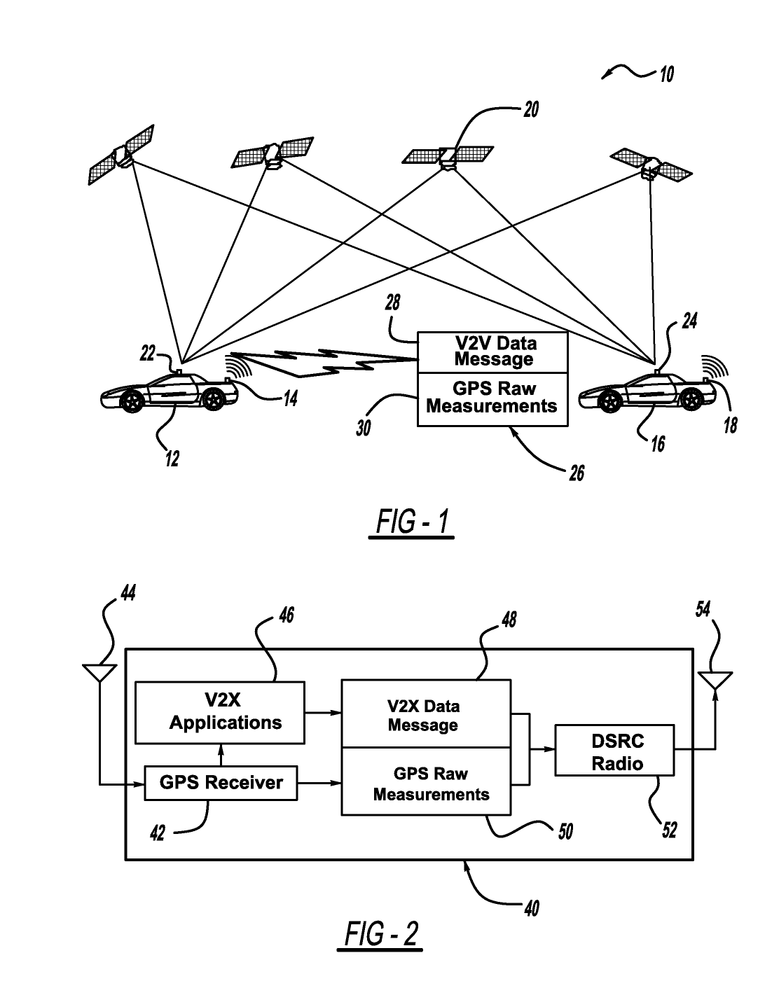

FIG. 1 is an illustration of a communications network 10 for vehicle-to-vehicle communications. A forward vehicle 12 includes a dedicated short-range communications (DSRC) unit 14 that may be sending messages 26 to other vehicles, such as a following vehicle 16 also including a dedicated short-range communications unit 18. The message 26 would include a V2V or V2X data portion 28 having various information about the sending vehicle, such as vehicle speed, vehicle position, acceleration, deceleration, status of various systems, such as stability systems, etc. The forward vehicle 12 includes a GPS receiver 22 that receives GPS signals from a constellation of satellites 20, and the following vehicle 16 includes a GPS receiver 24 that also receives the GPS signals from the satellites 20.

According to the invention, the message 26 also includes a raw GPS measurement portion 30 that the vehicle 12 received by its GPS receiver 22. As is understood in the art, these GPS signals will typically include a time-marked ranging code, a carrier wave and navigation data containing satellite and environment related information. The GPS receivers 22 and 24 track and measure carrier phase to read the ranging code, and the user-to-satellite range is measured once the code is read. Typical range measurement accuracy with random noise code is 1-2 meters, and a receiver location is estimated using four or more range codes. Typical user accuracy can be achieved of about 2-10 meters.

The raw GPS measurement portion 30 in the message 26 received by the vehicle 16 can then be used to process an RTK solution that includes the position, velocity, acceleration and heading of the vehicle 12 in the same manner that the vehicle 12 used the same raw GPS data to calculate this information. The vehicle 16 can compare the calculated position of the vehicle 12 to the position of the vehicle 12 provided in the V2V data portion 28 that the user has calculated from the GPS raw measurement data to define its position. If these two positions do not match within a certain threshold, then the vehicle 16 will know that the vehicle 12 is not broadcasting its accurate position, whether intentional or not. Therefore, the vehicle 16 can assume that other information in the data portion 28 is invalid, and can take suitable action, such as disregard the message, notify the driver that the message may be inaccurate, etc.

FIG. 2 is a block diagram of a sender communications system 40 that generates messages in a sending vehicle, according to an embodiment of the present invention. The sender system 40 includes a GPS receiver 42 that receives GPS signals from the satellites 20 by an antenna 44. The GPS receiver 42 sends the vehicle position, velocity, acceleration and heading estimated using GPS signals to a V2X applications processor 46 that generates a V2X data message 48. The applications processor 46 will use the GPS position, velocity, acceleration and heading of the sending vehicle provided by the GPS receiver 42, and format the message 48 with the position information and all of the other information that the system 40 will broadcast in the message 48. Additionally, the GPS receiver 42 provides raw GPS measurement data 50 to be attached to the message 48, which is then sent to a DSRC radio 52 to be modulated onto a carrier wave and transmitted by an antenna 54.

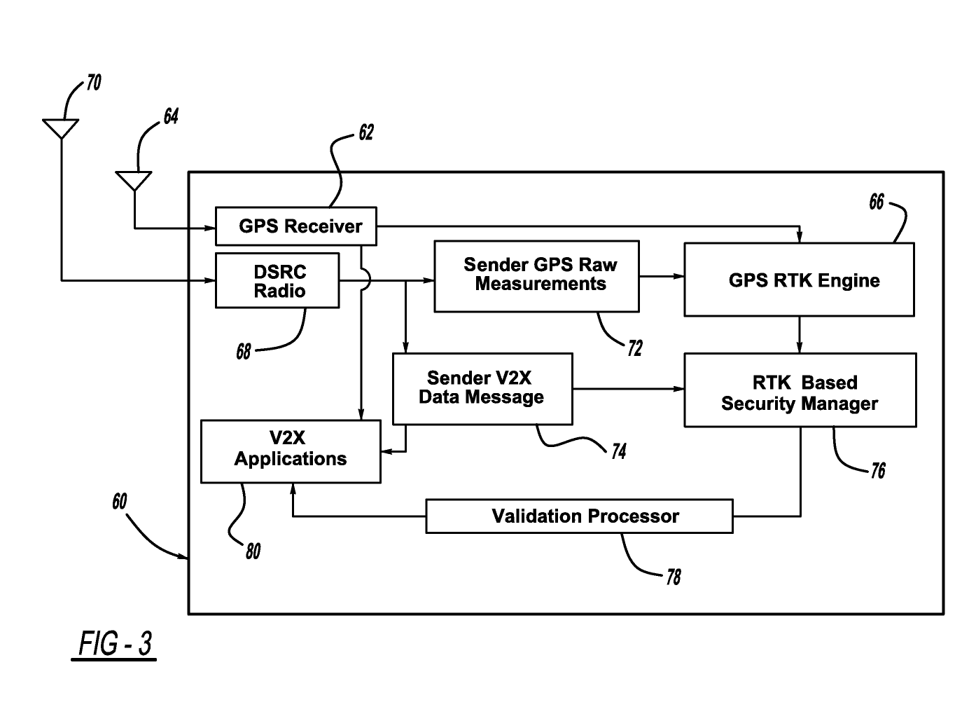

FIG. 3 is a block diagram of a receiver system 60 in a receiving vehicle that will use raw GPS measurement data received in a message from a sending vehicle to validate the message. The system 60 includes a GPS receiver 62 that receives GPS signals from the satellites 20 by an antenna 64. The GPS receiver 62 determines the position, velocity, acceleration and heading of the receiving vehicle and sends the information to an applications processor 80. In an alternate implementation, this information for the receiving vehicle can be determined by an RTK engine 66 using GPS raw data from the GPS receiver 62 and GPS raw data sent by a V2I sender. The system 60 also includes a DSRC radio 68 that receives the messages from the sending vehicle by an antenna 70 where the messages are demodulated and separated into the sending vehicle's raw GPS measurements 72 and the sending vehicles data message 74. The raw measurements 72 are also sent to the RTK engine 66 that calculates the precise relative position of the sending vehicle based on the raw data.

The calculated position of the sending vehicle is sent to an RTK-based security manager 76 along with the data message 74, where the manager 76 compares the calculated position, velocity, acceleration and heading of the sending vehicle by the engine 66 with the stated position, velocity, acceleration and heading of the sending vehicle in the message 74 to determine whether they are within some threshold. The difference between the calculated position of the sending vehicle and the stated position of the sending vehicle is determined by a validation processor 78 that compares the difference to some threshold. The validation processor 78 notifies a V2X applications processor 80 on the receiving vehicle as to whether the data message 74 is authentic. For various applications, the V2X applications processor 80 on the receiving vehicle can use the data message 74 in different manners, assuming the validation processor 78 determines that the message is invalid. These applications can include warning the driver of braking activity or not depending on whether the message is determined to be valid.

V2V applications typically have fast validation response needs generally ranging from 1-3 seconds, as shown by Table 1 below. The proposed method of using the GPS raw measurements, as discussed above, can provide a 50% confidence that the sending vehicle is sending a valid message within 1.5 seconds and a 95% confidence that the sending vehicle is sending a valid message in 4 seconds using current GPS RTK systems. These statistics are presented only to reflect the capabilities of the current state of the art where the time required is expected to considerable shorten with the use of multiple frequency GPS and using other Global navigation Satellite System (GNSS) signals.

TABLE 1

| Application | Tolerance (sec) |
|---|---|
| Emergency Electronic Brake Lamps | 0.1-2.0 |
| Road Condition Warning | 0.1-3.0 |
| Slow/Stopped Vehicle Ahead | 0.5-3.0 |
| Post Crash Warning | 0.5-3.0 |
| Forward Collision Warning | 0.1-1.0 |
| Lane Change Warning | 0.1-1.0 |
| Blind Spot Warning | 0.1-1.0 |

The present invention offers a number of advantages for authenticating a message in a vehicle-to-vehicle communications system. For example, raw GPS data is impossible to fabricate and therefore a reliable source of data for security against data alterations and fabrication. Further, raw GPS data is already shared for relative positioning in several OEM collaborative projects and therefore likely will become standard. Raw GPS data is used for two extremely important functions, namely, precise relative position using RTK and sender information validation for security. Because of the dual use, more resources, i.e., processing power and communication bandwidth, can be dedicated for RTK with benefits from better positioning accuracy and reliable security.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A communications system comprising:
a sending sub-system receiving GPS signals, said sending sub-system generating a message to be sent that includes a data portion and a raw GPS measurement portion, said raw GPS measurement portion including at least part of the data received in the GPS signals and said data portion including a calculation of the sending sub-system's position using the GPS signals, said sending sub-system transmitting the message; and
a receiving sub-system that receives the message from the sending sub-system, said receiving sub-system using the raw GPS measurements in the message to determine the position of the sending sub-system and comparing the determined position of the sending sub-system with the calculated position in the data portion of the message to determine whether a match exists to determine the validity of the message.

2. The system according to claim 1 wherein the system is a vehicle-to-vehicle communications system where the sending sub-system is on a sending vehicle and the receiving sub-system is on a receiving vehicle.

3. The system according to claim 2 wherein the data portion of the message includes information about the sending sub-system including vehicle speed, vehicle acceleration, vehicle deceleration and vehicle stability control.

4. The system according to claim 1 wherein the receiving sub-system includes a GPS real-time kinematic (RTK) engine that uses a real-time kinematics process to determine the position of the sending sub-system using the raw GPS measurements in the message.

5. The system according to claim 4 wherein the receiving sub-system includes an RTK-based security manager that compares the calculated position of the sending sub-system in the data portion of the message with the determined position of the sending sub-system to determine the validity of the message.

6. The system according to claim 1 wherein the raw GPS measurement portion of the message includes time-marked ranging codes and a carrier wave.

7. The system according to claim 1 wherein the sending sub-system and the receiving sub-system also determine the velocity, acceleration and heading of the sending sub-system to validate the message.

8. A communications system for transmitting messages between vehicles, said system comprising:
a sending sub-system on a sending vehicle receiving GPS signals, said sending sub-system generating a message to be sent that includes a data portion and a raw GPS measurement portion, said raw GPS measurement portion including at least part of the data received in the GPS signals and said data portion including a calculation of the sending sub-system's position using the GPS signals, said sending sub-system transmitting the message; and
a receiving sub-system on a receiving vehicle that receives the message from the sending sub-system, said receiving sub-system including a GPS real-time kinematics engine that uses a real-time kinematic (RTK) process to determine the position of the sending sub-system using the raw GPS measurements in the message, said receiving sub-system including an RTK-based security manager that compares the calculated position of the sending sub-system in the data portion of the message with the determined position of the sending sub-system to determine the validity of the message.

9. The system according to claim 8 wherein the data portion of the message includes information about the sending sub-system including vehicle speed, vehicle acceleration, vehicle deceleration and vehicle stability control.

10. The system according to claim 8 wherein the raw GPS measurement portion of the message includes time-marked ranging codes and a carrier wave.

11. The system according to claim 8 wherein the sending sub-system and the receiving sub-system also determine the velocity, acceleration and heading of the sending sub-system to validate the message.

12. A communications system for transmitting messages between vehicles, said system comprising a sending sub-system on a sending vehicle receiving GPS signals, said sending sub-system generating a message to be sent that includes a data portion and a raw GPS measurement portion, said raw GPS measurement portion including at least part of the data received in the GPS signals.

13. The system according to claim 12 further comprising a receiving sub-system that receives the message from the sending sub-system, said receiving sub-system using the raw GPS measurement portion in the message to validate the message.

14. The system according to claim 13 wherein the receiving sub-system uses a real-time kinematic (RTK) process to determine the position of the sending sub-system using the raw GPS measurements in the message, said receiving sub-system comparing a calculated position of the sending sub-system in the data portion of the message with the determined position of the sending sub-system to determine the validity of the message.

15. The system according to claim 14 wherein the sending sub-system and the receiving sub-system also determine the velocity, acceleration and heading of the sending sub-system using the raw GPS measurements to validate the message.

16. The system according to claim 12 wherein the raw GPS measurement portion of the message includes time-marked ranging codes and a carrier wave.
